(19) United States
(12) Patent Application Publication
(10) Pub. No.: US 2011/0320113 A1
(43) Pub. Date: Dec. 29, 2011

(54) GENERATING DRIVING ROUTE TRACES IN A NAVIGATION SYSTEM USING A PROBABILITY MODEL

(75) Inventor: Edward D. Tate, JR., Grand Blanc, MI (US)

(73) Assignee: GM GLOBAL TECHNOLOGY OPERATIONS, INC., Detroit, MI (US)

(21) Appl. No.: 12/823,286

(22) Filed: Jun. 25, 2010

(51) Int. Cl. G01C 21/36; G06N 5/02

(52) U.S. Cl. 701/200; 706/52

(57) ABSTRACT

A navigation system includes a display screen and a host machine operable for calculating and displaying a recommended travel route within a road network using a Markov or other probability model. The probability model statistically models a distribution pattern of speed or other actual driving behavior within a road network. An input device may record risk aversion of a user, with the host machine calculating the recommended travel route using the risk aversion. The host machine reduces the model to a single cost, and then uses the single cost in a Dijkstra algorithm or other costing function to calculate the recommended travel route. A method of operating the navigation system includes calculating the recommended travel route using a probability model, and displaying the recommended travel route via the display screen. The host machine may calculate the recommended travel route using risk aversion entered via an input device.

### TECHNICAL FIELD

The present invention relates to the calculation and display of travel route information within a vehicle.

### BACKGROUND

Vehicle navigation systems are networked computer devices which use global positioning data to accurately determine a position of the vehicle. A host machine calculates a recommended travel route using the position and associated geospatial, topographical, and road network information, and then presents the recommended route to a user on a display screen. A vehicle navigation system may also provide precise turn-by-turn driving directions to other locations of interest contained in a referenced mapping database.

Vehicle navigation systems can use mapping databases to determine the recommended route based on closest distance, fastest drive time, or easiest driving route. Hybrid, battery electric, and extended-range electric vehicles have electric-only operating modes, also referred to as EV modes, in which the vehicle is propelled solely using electrical power. Navigation systems for these vehicles may also display “eco-route” information between an origin and a selected destination which tends to maximize the duration of travel in EV mode, thus minimizing fossil fuel consumption.

### SUMMARY

A navigation system and method of use are provided herein which determine recommended travel routes using a probability function in order to provide improved estimates of onboard energy use. The vehicle navigation system enables risk-averse routing, and may be configured to calculate travel routes corresponding to a particular user's selected level of risk aversion or level of tolerance with respect to possible travel delays. That is, a probability model represents known statistical distributions of vehicle speed and other actual driving behavior on the roads comprising a road network. In one embodiment, a driver may select a level of risk aversion using an input device, and a host machine automatically calculates and displays a recommended travel route that considers the risk aversion using the probability model as set forth herein.

In particular, a navigation system includes a host machine and a display screen. The host machine is operable for calculating and displaying a recommended travel route within a road network using a probability model, wherein the probability model statistically models a distribution pattern of actual driving behavior on a set of roads within a road network. An input device such as a dial or touch-screen device may be used for recording the level of risk aversion of a user to travel delays, with the host machine calculating the recommended travel route using the level of risk aversion.

The probability model, which may include one or more Markov chains to thereby form a Markov model, may statistically model an actual vehicle speed distribution along different roads within the road network. The host machine reduces the Markov model to a single cost, and then uses the single cost in a Dijkstra algorithm or other costing function to calculate the recommended travel route. The recommended travel route can be a route having the lowest energy consumption relative to all other possible routes in the road network.

A method of operating a vehicle navigation system having a display screen and a host machine includes using the host machine to calculate a recommended travel route within a road network using a probability model, wherein the probability model statistically models a distribution pattern of actual driving behavior on a set of roads within a road network, and displaying the recommended travel route via the display screen. An input device may record a level of risk aversion of a user, with the method including calculating a recommended travel route that includes using the level of risk aversion from the input device.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having a navigation system as disclosed herein;

FIG. 2 is a schematic illustration of a navigation system usable with the vehicle shown in FIG. 1; and

FIG. 3 is a flow chart describing an algorithm usable with the navigation system of FIG. 1.

### DESCRIPTION

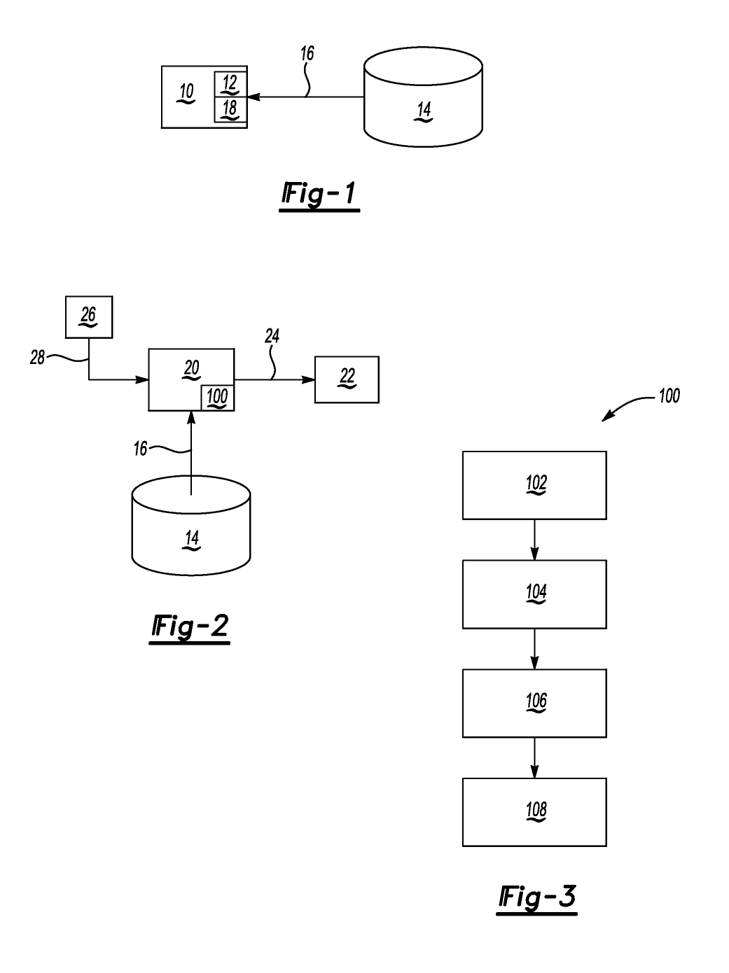

Referring to the drawings, wherein like reference numbers correspond to like or similar components throughout the several figures, a vehicle 10 is shown in FIG. 1 that includes a navigation system 12. The navigation system 12 is in communication with a geospatial mapping database 14. Mapping database 14 provides encoded geospatial mapping data 16 to the navigation system, including geocoded mapping information which may be encoded with probability density information. For example, a probability density function can statistically model the historical distribution of speeds of the general population along different roads comprising the various possible travel routes for vehicle 10. The navigation system 12 uses the encoded mapping data 16 to account for a user's potentially unique level of risk aversion, i.e., a relative level of tolerance for potential travel delays of various causes which could, if present, adversely affect the speed of travel along a given route and/or availability of a particular road segment for use in that route when planning a trip.

The location of mapping database 14 with respect to the vehicle 10 may vary. For example, a telematics unit 18 positioned aboard vehicle 10 may include electronic data transmission and receiving circuitry enabling remote communication with the mapping database 14, or the mapping database may be software-driven and available onboard the vehicle.

Referring to FIG. 2, navigation system 12 includes a host machine 20 and a display screen 22. Host machine 20 may be configured as a single or a distributed digital computer generally comprising a microprocessor or central processing unit, read only memory (ROM), random access memory (RAM), electrically-erasable programmable read only memory (EEPROM), a high-speed clock, analog-to-digital (A/D) and digital-to-analog (D/A) circuitry, and input/output circuitry and devices (I/O), as well as appropriate signal conditioning and buffer circuitry.

Host machine 20 executes an algorithm 100, an embodiment of which is shown in FIG. 3, in order to calculate and display a recommended travel route 24. Host machine 20 is in communication with mapping database 14, either directly or remotely as noted above. Mapping database 14 provides the encoded geospatial mapping data 16 to the host machine 20 so as to enable the host machine to calculate and display the recommended travel route 24 on a geocoded map using the display screen 22.

In one possible embodiment, mapping data 16 may be encoded with road network probability information to allow host machine 20 to consider the probability that a given road in a recommended travel route will conform to a user's level of risk aversion. Such probability information describes a distribution or probability density function of speeds on roads comprising the various possible routes. That is, events such as accidents, road construction, or weather conditions can greatly affect the speed one may expect to attain on a given road. Likewise, at some times of day one might expect to travel at or near the posted speed limit, while at other times of day traffic may move much more slowly. A probability density function as used herein quantifies the probability that a given speed is attainable, and therefore is used by the host machine 20 in calculating and displaying the recommended travel route 24.

Still referring to FIG. 2, an input device 26 may be configured to transmit an acceptable risk value 28 to the host machine 20. For example, input device 26 may be a dial or touch pad suitable for determining a user's level of risk aversion. A dial may allow a user to select an acceptable level of risk aversion from one end of a calibrated scale to another, while a touch pad could allow a user to select from different preset risk levels. Host machine 20 is adapted to process the user's risk aversion as determined by input device 26 in conjunction with a probability density function in calculating the recommended travel route 24.

For illustration, consider a scenario in which a user selects a route origin and destination, and then indicates a relatively high level of risk aversion by entering a corresponding risk value 28 via input device 26. In generating the recommended travel route 24, host machine 20 can look at historical driving patterns on different roads potentially comprising the recommended travel route 24. For illustration, consider a road located along a possible route, with average travel speeds equaling 70 miles per hour (mph) 95 percent of the time. Three percent of the time, the average speed might be 50 mph. The average speed might be just 35 mph the remaining two percent of the time.

In this particular scenario, host machine 20 has knowledge that the user is highly risk averse as determined by the risk value 28, and therefore could disregard the most likely 70 mph speed average in calculating recommended travel route 24. Instead, host machine 20 could use one of the other average speeds, i.e., 50 mph or 35 mph in the above example, depending on the level of risk aversion, and therefore may or may not ultimately recommend this particular road as part of recommended travel route 24.

Referring to FIG. 3 in conjunction with the structure shown in FIG. 2, algorithm 100 begins with step 102, wherein a user of the navigation system 12 records a route destination and risk value 28, for example using the input device 26. Once recorded, the algorithm 100 proceeds to step 104.

At step 104, host machine 20 processes the encoded geospatial mapping data 16 and risk value 28 to thereby calculate an energy cost of traveling along the various possible travel routes between current position of the vehicle 10 of FIG. 1 and the recorded route destination from step 102. Step 104 may entail attaching a conditional probability model to each road segment of a possible travel route, e.g., as one or more Markov models. The Markov models may be reduced to a single cost, with feedback provided as needed from the vehicle 10 of FIG. 1.

For example, consider the following costing formula, wherein the costs of different route segments are represented as a probability-based cost function:

$$c ( x , u , w ) = {\sum }_{v , a} Pr ( v , a \vert w ) \cdot {c}_{veh} ( v , a )$$

wherein the function of cost (c) for traveling from a point (x) to a given next reasonable choice (u), i.e., a next road segment, may be calculated as a function of probability (Pr).

At step 106, host machine 20 uses the cost from step 104 as part of a costing function, e.g., in a Dijkstra or similar algorithm, to calculate a solution that minimizes the cost function, with this solution being the recommended travel route 24. For example:

$${V}^{*} ( x ) = {min}_{u} \{ {\sum }_{w} Pr ( w ) \cdot g ( c ( x , u , w ) ) + {V}^{*} ( f ( x , u ) ) \} .$$

Following from this formula, one may determine the cost-minimizing solution noted above:

$${u}^{*} ∈ arg {min}_{u} \{ {\sum }_{w} Pr ( w ) \cdot g ( c ( x , u , w ) ) + {V}^{*} ( f ( x , u ) ) \}$$

wherein g is a calibrated value interpreting the cost (c) of the different possibilities, e.g., 70 mph, 50 mph, 35 mph in the example above.

At step 108, the host machine 20 transmits the recommended travel route 24 to the display screen 22, where the recommended travel route is ultimately displayed to a user.

Accordingly, while traditional navigation systems perform a cost analysis to determine and evaluate different possible travel routes, the present navigation system 12 adds distribution information so as to generate risk-appropriate routing choices. These routes are customizable, i.e., a user can select their level of risk, and the host machine 20 generates recommended travel route 24 in part using this information. As a result, there is a reduced likelihood of a driver being presented with a route that differs from their subjective expectations.

While the best modes for carrying out the invention have been described in detail, those familiar with the art to which this invention relates will recognize various alternative designs and embodiments for practicing the invention within the scope of the appended claims.

1. A vehicle navigation system comprising:
a display screen; and
a host machine operable for calculating a recommended travel route within a road network using a probability model, and for displaying the recommended travel route via the display screen;
wherein the probability model statistically models a distribution pattern of actual driving behavior on a set of roads within a road network.

2. The system of claim 1, further comprising an input device for recording a level of risk aversion of a user to possible travel delays, wherein the host machine calculates the recommended travel route using the level of risk aversion.

3. The system of claim 2, wherein the input device is one of a dial and a touch-screen device.

4. The system of claim 2, wherein the input device is further operable for recording a route destination.

5. The system of claim 1, wherein the probability model statistically models an actual vehicle speed distribution along different roads within the road network.

6. The system of claim 1, wherein the host machine is in communication with a geospatial mapping database which transmits encoded geospatial mapping information including the probability model to the host machine.

7. The system of claim 1, wherein the probability model includes a Markov chain.

8. The system of claim 7, wherein the host machine reduces the Markov model to a single cost, and then uses the single cost in a costing function to calculate the recommended travel route.

9. The system of claim 8, wherein the costing function is a Dijkstra algorithm.

10. The system of claim 1, wherein the recommended travel route is a route having the lowest energy consumption relative to all other possible routes in the road network.

11. A method of operating a vehicle navigation system having a display screen and a host machine, the method comprising:
using the host machine to calculate a recommended travel route within a road network using a probability model, wherein the probability model statistically models a distribution pattern of actual driving behavior on a set of roads within a road network; and
displaying the recommended travel route via the display screen.

12. The method of claim 11, the navigation system including an input device for recording a level of risk aversion of a user to possible travel delays, wherein using the host machine to calculate a recommended travel route includes using the level of risk aversion from the input device.

13. The method of claim 12, wherein the input device is one of a dial and a touch-screen device.

14. The method of claim 12, further comprising using the input to record a route destination.

15. The method of claim 11, wherein using the host machine to calculate a recommended travel route within a road network using a probability model includes statistically modeling an actual vehicle speed distribution along different roads within the road network.

16. The method of claim 11, wherein the host machine is in communication with a geospatial mapping database, the method further comprising:
using the host machine to process encoded geospatial mapping information from the geospatial mapping database, the encoded geospatial mapping information including the probability model.

17. The method of claim 11, wherein the probability model includes a Markov model, the method further comprising:
reducing the Markov model to a single cost, and then using the single cost in a costing function to calculate the recommended travel route.
